(19) United States
(12) Patent Application Publication
(10) Pub. No.: US 2010/0063640 A1
(43) Pub. Date: Mar. 11, 2010

(54) Programmable Animal Lure Aerosol Dispenser

(76) Inventor: David Olmstead, Panama City, FL (US)

Correspondence Address: STURM & FIX LLP, 206 SIXTH AVENUE, SUITE 1213, DES MOINES, IA, 50309-4076, US

(21) Appl. No.: 12/205,331

(22) Filed: Sep. 5, 2008

(51) Int. Cl. G05D 7/06; A01M 31/00

(52) U.S. Cl. 700/283; 43/1

(57) ABSTRACT

A deer lure dispensing apparatus and method of use including a programmable dispensing system for effecting automatic dispersal of the lure. The hunter or other user programs a predetermined schedule for dispensing lure such as deer urine. Once the programmable, automatic animal lure dispensing unit is placed in the field, no human intervention is needed to effect the scheduled dispersals of lure.

### BACKGROUND OF THE INVENTION

### CROSS REFERENCE TO RELATED APPLICATIONS

1. Field of the Invention

The present invention relates to the field of animal lure dispensers in general, and in particular, to a programmable, aerosol-based animal lure dispensing method and apparatus providing the ability to programmably time the dispensing of the lure.

2. Description of Related Art

As can be seen by reference to U.S. Pat. No. 6,443,434 by Prather, as well as U.S. Pat. Nos. 6,550,689; 6,648,239; 5,738,851, and US patent application US 2004/0064995 A1, the prior art is replete with myriad and diverse animal, and especially deer, lure dispensing systems.

Most game lure dispensing systems presently available require a human to be present for operation and/or dispense lure on non-programmable bases. The drawback of this is clear to any hunter whose game is able to detect the presence of a human by scent.

The Prather reference recognizes the inherent deficiencies in the well-known prior art drag and/or multiple scent wick dispersal systems and suggests an automated, timed release of the lure. However, a problem associated with the Prather scent dispersal system is that significant power is required to heat the lure via resistance heat. A fan is also used, and requires electrical power over and above that of the resistance heat. Therefore, the battery of the Prather unit will either have a very short lifespan, or will be large and bulky. In either instance, locating the Prather lure dispenser in a remote field location is problematic.

Aerosol dispensed animal lures have relatively recently been introduced in the marketplace. The aerosol dispensing aspect of these lures provides clean, convenient dispensing in the field.

There exists a longstanding need among hunters for a new and improved automatic, programmable, aerosol based scent dispersal device to dispense game animal lure, such as deer urine, on a predetermined time basis.

### BRIEF SUMMARY OF THE INVENTION

It is an object of the present invention to provide an aerosol dispensing method and apparatus to automatically dispense an animal lure on a programmable schedule. Another object of the present invention is to provide a programmable aerosol dispenser that requires a minimum of maintenance and visits while operating.

The deer lure aerosol dispensing method and apparatus forming the basis of the present invention comprises, in general, an aerosol container containing animal lure, for instance liquid deer urine; and a timed dispenser system for actuating the aerosol container to dispense a quantity of lure at predetermined times. The dispensing system comprises a microcontroller programmed to accept details of a dispensing schedule and an actuator for opening the aerosol container's valve to release the animal lure according to the predetermined schedule.

The actuation of the aerosol container may take a form similar to that used to dispense deodorant or insecticide inside buildings. Unlike these common devices, the present device will include a scheduling system, capable of accepting and storing dates and times to dispense the lure. An operator, such as the hunter, enters dates and time spans during those days dispensing is desired. In this way, hunters may place the lure near a tree-stand or blind, enter the dates and times for dispensing, and leave the unit. An advantage of the present invention is no human needs to be near the lure dispensing device, so no fresh human scent will be detected by the deer or other game. The dispensing unit may be placed well before the season starts to accustom, train and condition, and/or fool the animals to approaching the area of the tree stand or blind. Then, during hunting season, the hunter does not need to approach the lure dispenser any closer than the blind or tree stand. The lure dispenser will continue to dispense lure on the days and during the times chosen, thereby conserving lure and extending the supply in the aerosol container, thus minimizing the frequency of its replacement and, therefore, human intrusion and contamination of the area. The advantages of the scheduling include a savings of money due to less frequent purchase of the lure, and a minimizing of the need to replace the aerosol container and batteries, thereby risking leaving fresh human scent to the area.

The energy requirements for the programmable, automatic lure dispensing device of the present invention are intentionally low. A quartz clock, a microprocessor, an actuator for opening the aerosol container's valve, and supporting components are all that are required. These components require only small amounts of energy to operate, so the battery or batteries used to supply that energy have long life.

Other objects, advantages, and novel features of the present invention will become apparent from the following detailed description of the invention when considered in conjunction with the accompanying drawings.

### BRIEF DESCRIPTION OF THE SEVERAL VIEWS OF THE DRAWINGS

FIG. 1 is a flow diagram of a first process for using the programmable lure dispenser of the present invention;

FIG. 2 is a flow diagram of a second process for using the programmable lure dispenser;

FIG. 3a is a depiction of scheduling information required to set up the programmable lure dispenser for use in a first embodiment of the present invention;

FIG. 3b is a depiction of scheduling information required to set up the programmable lure dispenser for use in a second embodiment of the present invention;

FIG. 4 is a perspective view of the programmable lure dispenser installed in the field;

FIG. 5 is a perspective view of the programmable lure dispenser, opened for replacing the aerosol container or for entering or checking scheduling data;

FIG. 6 is an exploded view of a clock mechanism and an actuating mechanism;

FIG. 7 is a perspective view of the lure dispenser with the case closed;

FIG. 8 is a perspective view of the lure aerosol container wherein a nozzle valve is not actuated;

FIG. 9 is a perspective view of the lure aerosol container wherein a nozzle valve is actuated and lure is being dispensed;

FIG. 10 is a flow diagram for logic to keep track of the contents of the aerosol container and to aid a user in scheduling applications;

FIG. 11 shows a hunter using a remote control device to control the programmable lure dispenser; and

FIG. 12 is a perspective view of the remote control device.

### DETAILED DESCRIPTION OF THE INVENTION

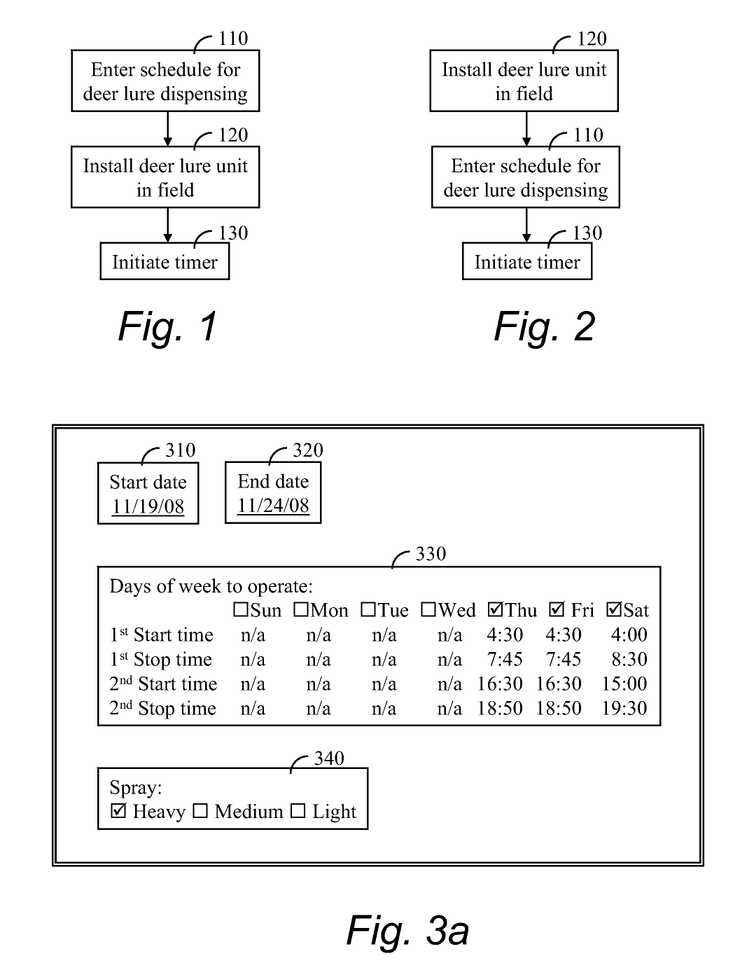

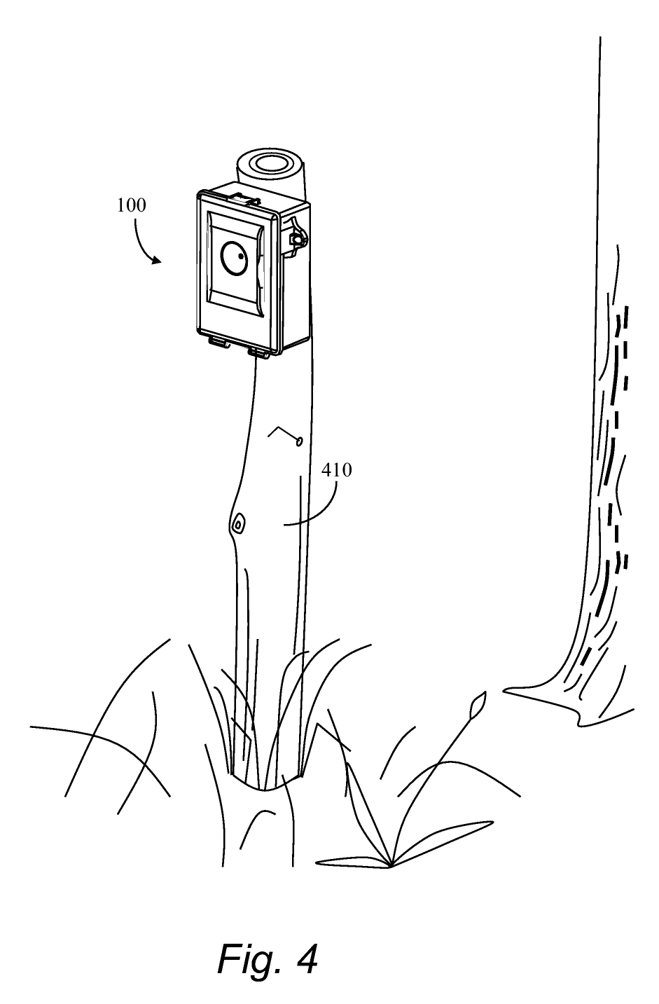

In FIGS. 1 and 2, flow diagrams are shown to indicate the simple steps for making use of the programmable, aerosol animal lure dispensing system 100 (see FIG. 4) of the present invention. The two flow diagrams are shown because the order of the steps may not be important. In FIG. 1, the first step is to enter the desired lure dispensing schedule, as indicated in block 110. The next step is to install the lure dispensing apparatus 100 in the desired location in the field as shown in FIG. 4. This is indicated in FIG. 1 by reference number 120. Such a location might be near the hunter's tree stand or blind. The installation could entail tying the lure dispensing device 100 to a branch in a tree, fastening it to a fence post or a post 410 placed for the purpose of this installation, setting the device on a rock, fastening it to the tree stand or blind, etc. The location of the device 100 is understood by those of ordinary skill in this art.

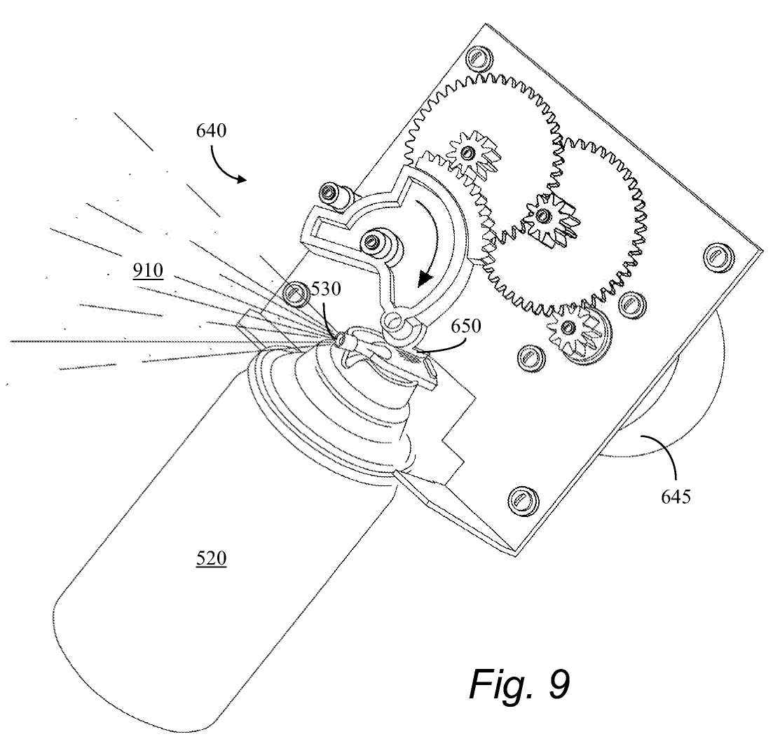

With the lure dispenser 100 in place, the unit 100 is turned on, as indicated in block 130, to begin its schedule of dispensing animal lure 910 (see FIG. 9).

In FIG. 2, the first step shown in block 120 is to install the lure dispensing apparatus 100 in the desired location in the field. Next, the desired lure dispensing schedule is entered into the lure dispensing system 100 as indicated in block 110. Finally, the unit 100 is turned on, as indicated in block 130. Hence, the lure dispensing schedule may be entered before or after installing in the field. In particular, the lure dispensing schedule for a lure dispensing system 100 already in the field may be modified without removing the unit 100.

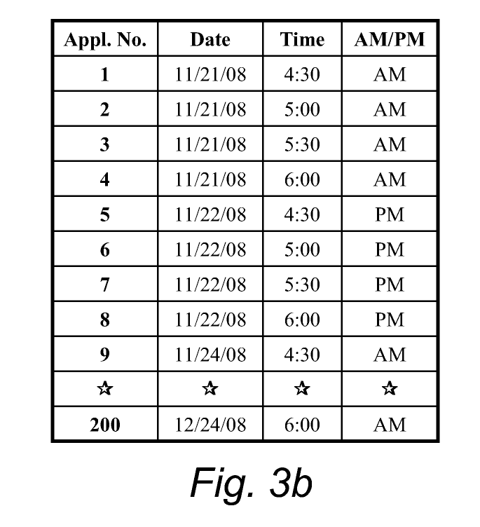

The data required, according to a first embodiment of this invention, are listed in FIG. 3a, along with some example entries. A start date 310 and an end date 320, are entered at the top of FIG. 3a. The lure dispensing system 100 will attempt to dispense lure during the time between these dates 310, 320.

The second set of required data 330 indicates which days of the week the automatic lure dispensing system 100 will dispense lure 910. Additionally, two time spans are provided each day during which lure 910 will be dispensed. The first time span is indicated by a first start time and a first end time. The second time span is indicated by a second start time and a second end time. Animal lure 910 will only be dispensed during these time spans on the day(s) chosen for lure 910 dispensing. Lure 910 will not be dispensed outside these time spans, or on days not chosen for lure dispensing.

A quantity of lure 340 dispensed at a given time is selected by choosing Heavy, Medium, or Light at the bottom of FIG. 3a. The application duration indicated by Heavy, Medium, or Light will depend on the lure being dispensed. Preferably, using deer urine, a light application would be a one-second mist, a medium application would be a two-second mist, and a heavy application would be a three-second mist.

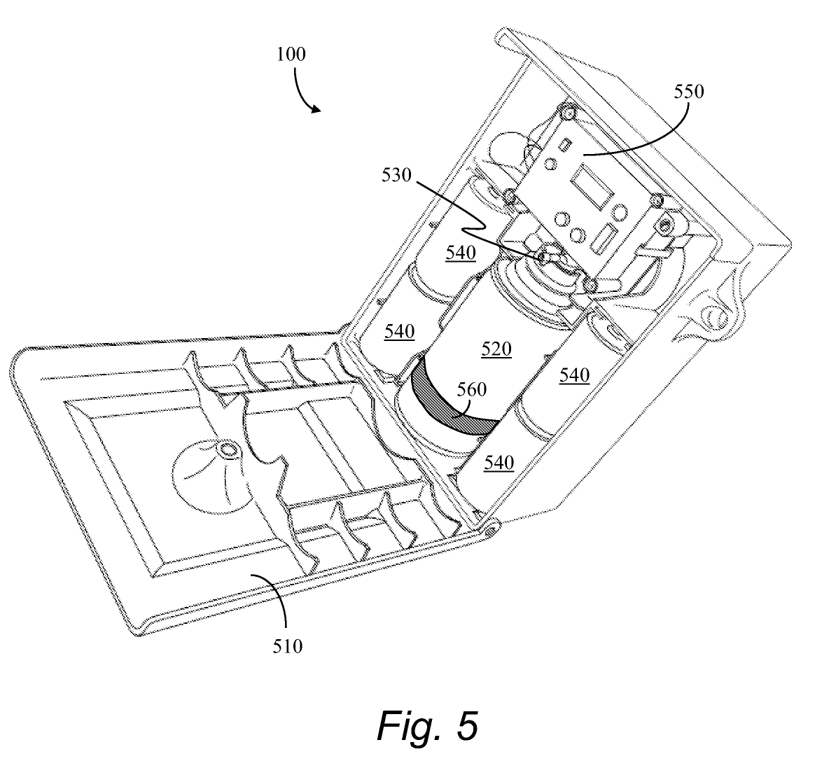

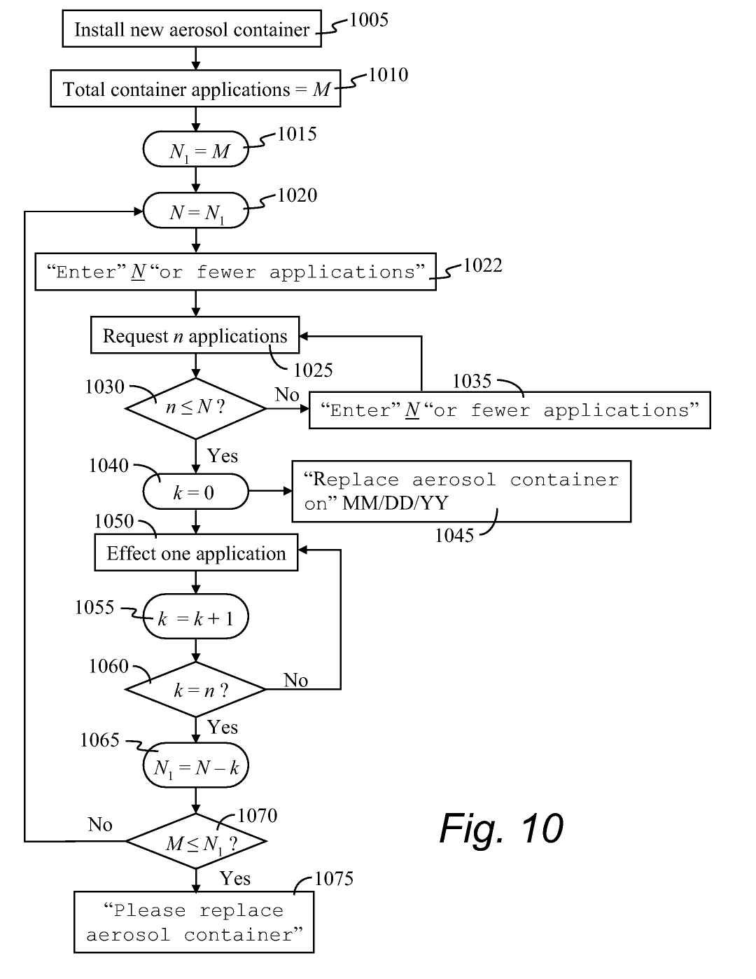

Scheduling information, required in an alternative embodiment of the present invention, is shown in FIG. 3b. In this embodiment, each application of the game animal lure 910 (see FIG. 9) is scheduled separately. A date, comprising a month, day, and year; a time of day; an indication of whether the time is before noon (AM) or after noon (PM) must be provided if the time is given on a twelve-hour clock basis, are the required data. The first column, Application Number, is provided by the system. The last column, AM/PM, may be entered by checking a box or similar. Note that logic within the programmable, aerosol animal lure dispensing system 100 may disallow more than a given number of applications based on the capacity of the aerosol lure container 520 (see FIG. 5), as depicted in FIG. 10 and described below. One way in which to limit the number of applications is to place a cap on the maximum value shown in the Application Number column, in the instance of FIG. 3b, this number is 200.

The automatic animal lure dispensing apparatus 100 is shown attached to a post 410 in the field in FIG. 4. As already mentioned, there are a plurality of appropriate locations and installation methods. The present invention is not limited to a location in the field or attachment methods. For the purposes of this document, including the claims, field is defined simply as outdoors. Examples include open areas, such as pastures, wooded areas, river or creek bottoms, an island, a golf course, or a lawn. As the present invention is not limited as to the animal(s) for which it may be applied, locations for its use will be many and varied.

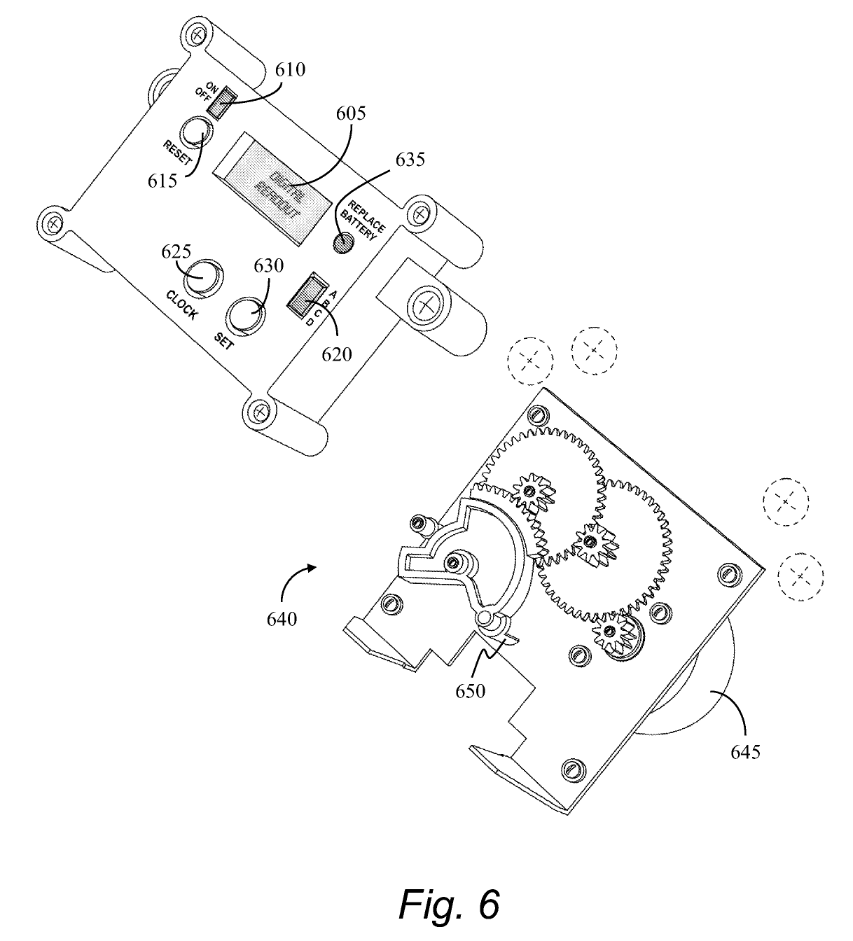

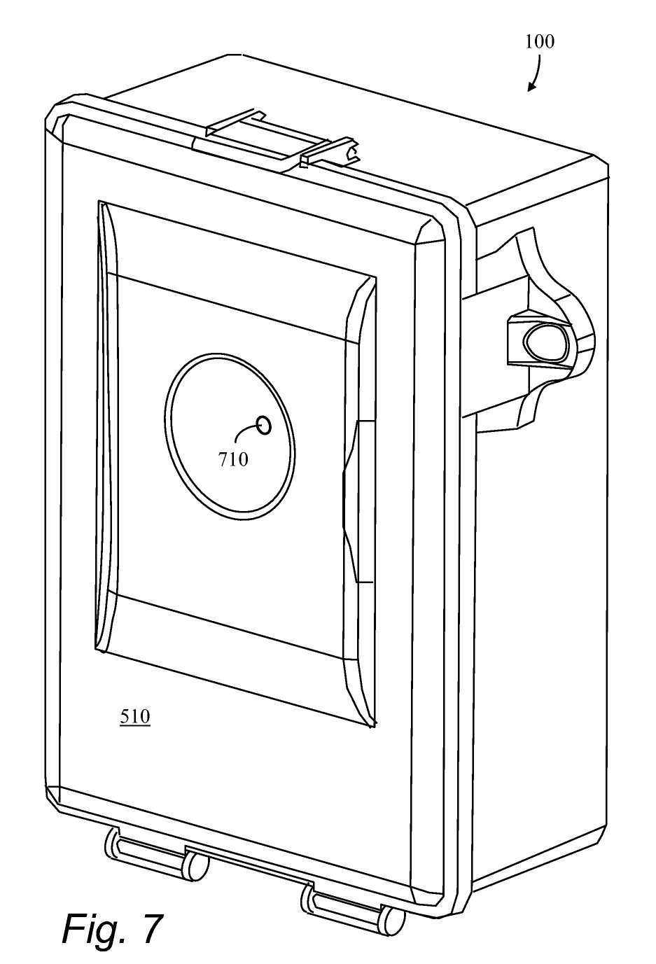

The automatic animal lure dispensing apparatus 100 is shown with its water tight cover 510 open in FIG. 5. An aerosol lure container 520 contains the animal lure 910, such as deer urine, under pressure. The nozzle 530 of the aerosol container 520 is made to be actuated for dispensing. Batteries 540, preferably a plurality thereof, are provided to supply electrical energy for the microprocessor and spray actuation. A user interface assembly 550 is shown in FIGS. 5 and 6, including the microprocessor (not visible), a display 605 which is preferably a Liquid Crystal Display (LCD) unit, and operator controls. The operator controls include an on/off switch 610, a reset button 615, a data input key 620, and two keys 625, 630 for displaying and controlling the clock. A low battery indicating light 635 is also shown to warn of the need to replace the batteries 540.

An optional heat strip 560 is shown in engaged to the aerosol lure container 520. The heat strip is intended to improve operation of the automatic animal lure dispensing apparatus 100 in cold conditions. Advantages of heating the lure in the aerosol lure container 520 include: keeping the lure 910 from freezing; making the scent more realistic to the game animal; and ensuring the lure 910 will travel farther in cold weather upon dispensing. The optional heat strip 560 is preferably thermostatically controlled, and is only permitted to provide heat during a predetermined period of time before an application of lure 910 is scheduled. Battery 540 power is thereby conserved.

Under the user interface assembly 550, is an actuation assembly 640. The preferred actuation assembly 640 is driven by a motor 645. A solenoid actuator, energized by command of the microprocessor, may also be used. The present invention is not limited to a particular actuation method.

The aerosol can's nozzle 530 is manipulated by an actuator finger 650. The frequency of actuation is programmable, as discussed above.

The programmable, automatic animal lure dispensing apparatus 100 is shown with its water tight cover 510 closed, as it would be in operation in the field, in FIG. 7. The lure 910 is ejected out an orifice 710, which is aligned with the aerosol can's nozzle 530.

The case in which the components 520, 530, 540, 550 are housed is water tight to keep the electronic components dry, and to avoid corrosion that can cause high resistance connections in this low voltage application.

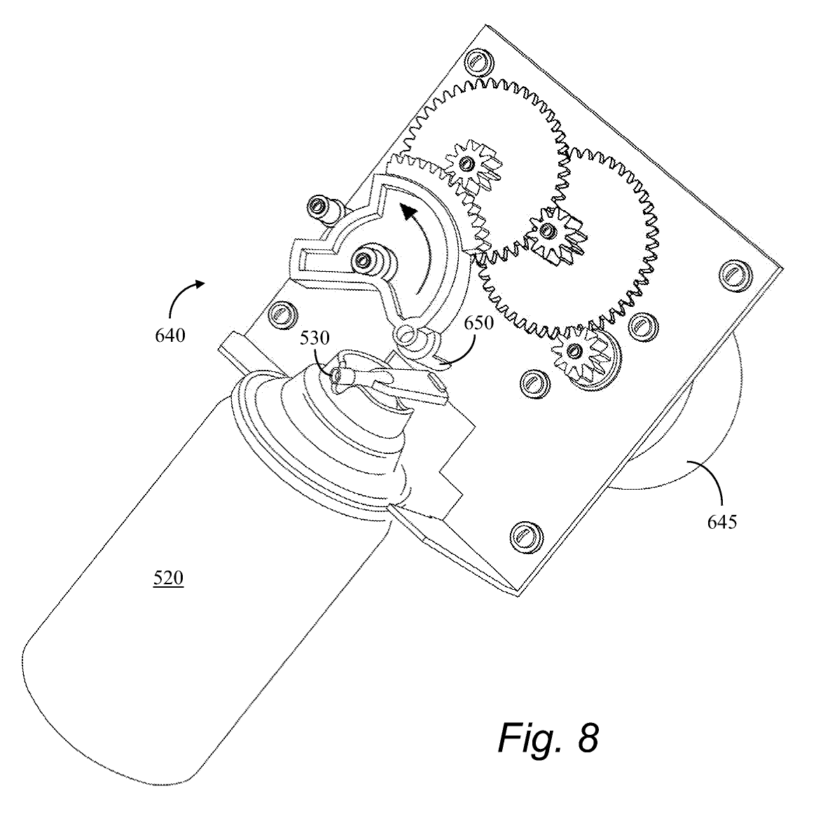

Actuation of the aerosol can's nozzle 530 is illustrated in FIGS. 8 and 9. In FIG. 8, the actuator finger 650 has not rotated to connect with the nozzle 530. When the time for dispensing the lure 910 arrives, the actuator finger 650 rotates toward a portion of the nozzle 530 which, when depressed, opens a valve (not shown). The actuator finger 650 has made contact with and depressed the portion of the aerosol can's nozzle 530 that results in lure 910 being dispensed in FIG. 9. Of course, other actuating mechanisms can be used instead of a motor and gears, such as a solenoid actuated plunger that pushes on the top of the nozzle 530 or simply a solenoid actuated valve.

Lures 910 for which this invention may be used include, but are not limited to, deer, moose, elk, or other big game animals or for smaller animals such as fox, coyote or raccoon.

As depicted in the flow diagram of FIG. 10, the control device may include logic to keep track of how many applications of lure 910 have been programmed into the device and how many applications of lure 910 are contained in the aerosol container 520. Then, if a user tries programming the device 100 for more applications than the present capacity of the aerosol container 520, the device 100 will provide an error message 1035, and will prompt the user to program only up to as many applications as are currently available in the aerosol container 520. This way the user will not think that lure 910 was dispensed when it was not.

Beginning at the top of FIG. 10, a new aerosol lure container 520 is installed in the automatic animal lure dispensing apparatus 100 in block 1005. In this way, a known quantity, measured in number of applications, of lure 910 is installed for a baseline measurement as shown in block 1010. The maximum number of applications contained in a new aerosol lure container 520 is given the quantity, M, in FIG. 10.

The instantaneous quantity of lure 910 in the aerosol lure container 520 is given the value, N₁, and thus N₁=M initially, as shown in block 1015.

The value, N, is simply a local placeholder for the instantaneous quantity of lure 910 in the aerosol lure container 520, so N=N₁ as shown in block 1020. A message is displayed in block 1022 to let the user know the maximum number of applications, N, permitted.

In block 1025, a user requests a number, n, of lure applications, according to FIGS. 3a or 3b. The value of n is compared to the quantity of lure 910 in the aerosol lure container 520, N, in a first comparator block 1030. If too many applications have been requested, a helpful warning message is displayed in block 1035, where the user is reminded of the maximum permitted number of applications, N.

If an appropriate number of applications have been requested as determined by the first comparator block 1030, a counter, k, is initialized to zero, and a message is generated in block 1045 to reveal what day the aerosol lure container 520 must be replaced. The replacement date is shown as MM/DD/YY in block 1045, where MM represents two digits for the month, DD represents two digits for the day of the month, and YY represents two digits for the year in the 21^{st} century.

At the scheduled time, an application of lure 910 is effected by the automatic animal lure dispensing apparatus 100, as indicated in block 1050. The counter, k, is incremented by one in block 1055 to keep track of the number of applications. The number of applications, k, is compared to the number of requested applications, n, in a second comparator block 1060 to determine if all the requested applications have been effected. If all the requested applications have not been issued, the flow returns to block 1050, where an additional application is effected at the scheduled time.

If the number of applications, k, is equal to the requested number of applications, n, the number of remaining applications, N₁, contained in the aerosol container 520 is calculated in block 1065, which is then compared to the capacity of a new aerosol container 520, M, in a third comparator block 1070. If there remain applications available in the aerosol container 520, the flow returns toward the top of the flow diagram, and the automatic animal lure dispensing apparatus 100 is ready for further applications as scheduled by the user. If the aerosol container 520 is empty, as estimated by the control system, a message is displayed, as shown in block 1075, to warn the user the aerosol container 520 must be replaced.

As those of ordinary skill will understand, the quantity of lure 910 contained in a new aerosol container 520 can be determined by experiment. For instance, a new aerosol container 520 may be emptied by a number of applications in the same way as it will be used in the field. The number of applications is counted and the quantity of lure 910 contained in the pressurized aerosol container 520 is given that value of applications.

Alternatively, a single application or a small number of applications can be effected and the quantity of a single application determined therefrom. The quantity of a single application is divided into the quantity of lure 910 contained in a new aerosol container 520 to calculate a number of expected applications. Again, this number is the capacity of the new aerosol container 520.

As an example, a present, new aerosol container 520 containing deer urine under the brand name BUCK BOMB averages 115 two second applications. Therefore, the BUCK BOMB aerosol container 520 should be replaced after a total of 99 two-second applications to ascertain lure 910 is available for each application scheduled. Hence, the control device of FIG. 10 would disallow more than 99 total applications of a single BUCK BOMB aerosol container 520. Other lure aerosol containers 520 may have different capacities, as may future BUCK BOMB aerosol containers 520.

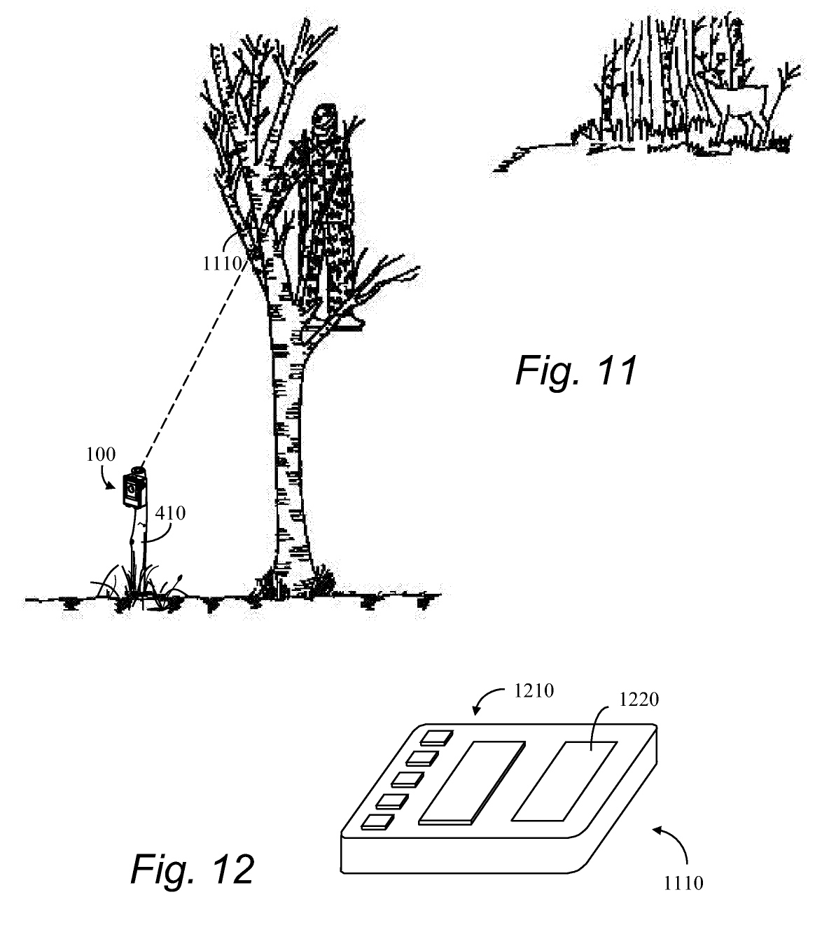

A hunter is shown in a tree stand in FIG. 11 using a remote transmitter 1110 to control the operation of the automatic animal lure dispensing apparatus 100 without approaching the automatic animal lure dispensing apparatus 100. The advantages of this feature include: use when a hunter needs to use a secondary stand because of a wind change; outfitters and guides may keep hunters from walking around stands to place fresh scent; a hunter may apply fresh scent when attempting to attract a buck from a distance downwind of the automatic animal lure dispensing apparatus 100.

The remote device 1110 is depicted in FIG. 12. Such a remote device may include a plurality of buttons 1210 or a touch pad, and a liquid crystal display screen 1220 for readout. Example uses of the remote device 1110 include: causing an immediate application of lure 910; disabling the automatic animal lure dispensing apparatus 100 due to rain, strong winds, etc.; programming a new lure dispensing schedule; and requesting the date of required replacement of the aerosol lure container 520.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

I claim:

1. A method of attracting game animals using a programmable lure dispensing unit comprising a programmable microprocessor, a pressurized aerosol container containing game animal lure, and an actuation system by which the aerosol container is actuated to dispense the game animal lure, the method comprising:
(a) selectably scheduling a game animal lure dispensing schedule in the programmable microprocessor;
(b) placing the programmable lure dispensing unit, including the pressurized aerosol container containing game animal lure, in the field; and
(c) energizing the programmable lure dispensing unit to begin the game animal lure dispensing schedule, including dispensing the game animal lure, at predetermined times.

2. The method of claim 1 wherein scheduling the game animal lure dispensing schedule comprises:
(a) entering a dispensing start date; and
(b) entering a dispensing end date.

3. The method of claim 1 wherein scheduling a lure dispensing schedule comprises:
(a) entering a list of days of a week on which to dispense the game animal lure;
(b) entering a dispensing start time of day for each day included in the list of days of the week; and
(c) entering a dispensing end time of day for each day included in the list of days of the week.

4. The method of claim 1 additionally comprising entering a heaviness of dispensing application into the microprocessor.

5. The method of claim 3 wherein the dispensing start time of day comprises a first dispensing start time of day and the dispensing end time of day comprises a first dispensing end time of day, the method additionally comprising:
(a) entering a second dispensing start time of day for each day included in the list of days of the week; and
(b) entering a second dispensing end time of day for each day included in the list of days of the week.

6. The method of claim 1 wherein placing the lure dispensing unit in the field comprises operatively attaching the lure dispensing unit to an installation point selected from the group consisting of a tree and a post.

7. The method of claim 1 additionally comprising installing a battery in the programmable lure dispensing unit.

8. The method of claim 1 additionally comprising installing the game animal lure in the programmable lure dispensing unit.

9. The apparatus of claim 1 wherein the game animal lure comprises urine from the type of animal being hunted by a human being.

10. The apparatus of claim 1 wherein the game animal lure comprises urine from the type of animal sometimes hunted by a predatory animal.

11. An apparatus for attracting game animals comprising:
(a) a programmable microprocessor;
(b) an aerosol container including a nozzle from which contents of the aerosol container may be dispensed;
(c) game animal lure contained in the aerosol container and dispensable therefrom;
(d) a source of energy;
(e) an actuator for actuating the aerosol container nozzle; and
(f) a selectable schedule, entered into the programmable microprocessor, on which to dispense the game animal lure from the aerosol container.

12. The apparatus of claim 11 wherein the game animal lure comprises deer urine.

13. The apparatus of claim 11 wherein the source of energy comprises at least one battery.

14. The apparatus of claim 11 wherein the selectable schedule comprises:
(a) a dispensing start date;
(b) a dispensing end date;
(c) a list of days of a week on which to dispense the game animal lure;
(d) a dispensing start time of day for each day included in the list of days of the week; and
(e) a dispensing end time of day for each day included in the list of days of the week.

15. The apparatus of claim 14 additionally comprising:
(a) a second dispensing start time of day for each day included in the list of days of the week; and
(b) a second dispensing end time of day for each day included in the list of days of the week.

16. The apparatus of claim 11 additionally comprising:
(a) a case with one open side to contain the microprocessor and source of energy; and
(b) a lid fitting the one open side of the case, the case in combination with the lid comprising a water tight container.

17. The apparatus of claim 11 wherein the game animal lure comprises urine from the type of animal being hunted by a human hunter.

18. The apparatus of claim 11 wherein the game animal lure comprises urine from the type of animal sometimes hunted by a predatory animal.

19. The method of claim 1 additionally comprising:
(a) determining a number of applications of game animal lure contained in the pressurized aerosol container;
(b) determining a number of requested applications based on the game animal lure dispensing schedule;
(c) comparing the number of applications of game animal lure contained in the pressurized aerosol container to the number of requested applications;
(d) disallowing the number of requested applications if the number of applications of game animal lure contained in the pressurized aerosol container is less than the number of requested applications.

20. The method of claim 19 additionally comprising providing a user an error message if the number of applications of game animal lure contained in the pressurized aerosol container is less than the number of requested applications.

21. The method of claim 19 additionally comprising:
(a) determining when the pressurized aerosol container is devoid of lure; and
(b) prompting a user to replace the pressurized aerosol container.

22. The method of claim 1 additionally comprising heating the pressurized aerosol container when a temperature of the pressurized aerosol container drops below a predetermined value.

23. The method of claim 1 additionally comprising using a remote device to control the programmable lure dispensing unit from a distance.

24. The method of claim 1 wherein scheduling the game animal lure dispensing schedule comprises entering at least one application schedule.

25. The method of claim 24 wherein the at least one application schedule comprises a month, day, year, a time in hours and minutes, and an indication of pre-noon or post-noon.

26. The method of claim 1 additionally comprising:
(a) estimating a date wherein the pressurized aerosol container will be empty based on the game animal lure dispensing schedule; and
(b) displaying a message to notify a user of said date.

27. The apparatus of claim 11 additionally comprising a heat strip operatively engaged to the aerosol container to heat the game animal lure inside the aerosol container.

28. The apparatus of claim 11 additionally comprising a remote device to control the programmable microprocessor from a distance.
